(19) United States
(12) Patent Application Publication
(10) Pub. No.: US 2019/0314823 A1
(43) Pub. Date: Oct. 17, 2019

(54) JAW CRUSHER SUPPORT FRAME

(71) Applicant: SANDVIK INTELLECTUAL PROPERTY AB, Sandviken (SE)

(72) Inventors: Martin JOHANSSON, Svedala (SE); Roger SJOBECK, Malmo (SE); Kim KOTKAMAA, Lund (SE); Marten LINDBERG, Malmo (SE)

(21) Appl. No.: 16/471,932

(22) PCT Filed: Dec. 21, 2016
(86) PCT No.: PCT/EP2016/082229

§ 371 Date: Jun. 20, 2019

(51) Int. Cl. B02C 1/04; B02C 1/02; B02C 1/10

(52) U.S. Cl. CPC B02C 1/04; B02C 1/10; B02C 1/025

(57) ABSTRACT

A jaw crusher having a movable jaw support frame configured to facilitate interchange between shim and wedge settings. The support frame is configured specifically to minimize stress concentrations and to provide the time efficient interchange between wedge and shim settings without a need to weld, cut and machine regions of the support frame.

### FIELD OF INVENTION

The present invention relates to a jaw crusher support frame to support a movable jaw of a jaw crusher via a mechanically actuated link assembly and in particular, although not exclusively, to a jaw support frame configured to facilitate interchange between wedge and shim setting modes of operation.

### BACKGROUND ART

Jaw crushers typically comprise a fixed jaw and a movable jaw that together define a crushing zone. A drive mechanism is operative to rock the movable jaw back and forth in order to crush material within this zone. The crushing zone is generally convergent towards its lower discharge end so that crushable material, fed to an upper and wider end of the zone, is capable of falling downward under gravity whilst being subject to repeated cycles of crushing movement in response to the cyclical motion of the movable jaw. The crushed material is then discharged under gravity through the lower and narrower discharge end onto a conveyor for onward processing or a stockpiling.

Commonly, the frame that supports the fixed and movable jaws is referred to as the front frame end. The front frame end of the movable jaw is connected to what is typically referred to as a back frame end via a mechanically actuated link mechanism that serves to control and stabilise the oscillating movement of the movable jaw relative to the stationary jaw. Typically, the link mechanism is both statically and dynamically linearly adjustable to control the grade or size of the resultant crushed material and to facilitate absorption of the impact forces generated by the crushing action.

Example jaw crushers of the type described above are detailed in WO 02/34393; EP 2564928; EP 2564929; U.S. Pat. No. 5,799,888; US 2006/0202075 and FR 2683462.

Typically, the construction of jaw crushers and in particular the back frame and front frame ends is a compromise between strength and weight. On the one hand the crusher (and importantly its component parts) is required to be sufficiently robust to withstand significant loading forces in use whist on the other hand very heavy crushers are undesirable to manufacture, transport and maintain.

Additionally, it is sometimes required to reconfigure a jaw crusher for operation in a ‘wedge’ setting from an earlier ‘shim’ setting. As will be appreciated, a wedge setting typically involves the mechanically actuated link assembly positioned between the back frame end and the jaw comprising an adjustable wedge assembly that is positioned to be at least partially accommodated within and in abutment contact with the back frame end. It will be further appreciated that a shim setting refers to a link assembly in which solid shim plates are positioned between the back frame end and a toggle beam, with this setting being implemented generally in less demanding operations that the wedge setting.

Conventionally, this reconfiguration is labour and time intensive involving modifying significantly the back frame end via welding, cutting and machining. In particular, this modification involves welding additional support ribs onto regions of the frame, cutting extended apertures within the frame end plates to accommodate the wedge setting components and machining numerous surface. As will be appreciated such modification is further disadvantageous as it can compromise the structural integrity of the support frame to withstand loading forces during use. Accordingly, what is required is a jaw crusher and in particular a jaw crusher support frame that addresses these problems.

### SUMMARY OF THE INVENTION

One objective of the present invention is to provide a jaw crusher support frame, typically referred to as a back frame end, which maximises the working strength of the frame whilst minimising its weight. It is a further objective to facilitate manufacture of a crusher support frame with regard to casting and machining of the frame part.

It is a further objective to provide a support frame for a jaw crusher that may be readily interchanged between two different types of working configuration being in particular ‘wedge’ and ‘shim’ setting. It is a further specific objective to avoid the need to machine, weld, cut or otherwise modify significantly the back frame end in order to adapt the frame for wedge setting configurations from shim setting configurations. It is a further objective to provide a back frame end that may be readily reconfigured from wedge to shim setting.

The objectives are achieved via a specific shape and configuration of the support frame having in particular specifically configured first and second flanges that project forwardly from a force transmission wall that is reinforced against loading forces imparted to the frame from the oscillating movement of the movable jaw. The objectives are further achieved by the configuration of wall and the first and second flanges (that between them define a cavity to receive a rearward end of a link assembly) that do not require structural modification to operate in either wedge or shim setting. Furthermore, the present support frame comprises a pair of respective end plates between which the first and second flanges and the force transmission wall extend that each comprise an aperture through which the wedge and the shim components may be introduced, extend and be interchanged depending upon the desired crusher setting.

According to a first aspect of the present invention there is provided a jaw crusher support frame to support a movable jaw of a jaw crusher via a mechanically actuated link assembly connected to the movable jaw, at least a part of the link assembly configured to allow the movable jaw to oscillate relative to a substantially stationary jaw in order to crush material in a zone between the movable and stationary jaws, the support frame comprising: a force transmission wall having a first side to be forward facing towards the movable jaw and a second side to be rearward facing away from the movable jaw, the first side having an abutment face aligned to extend generally in a plane transverse or perpendicular to a longitudinal axis of the link assembly; a first and a second flanges extending lengthwise along the wall and projecting widthwise forward from the first side of the wall to extend towards the movable jaw, a cavity defined between the first and second flanges to receive at least a part of the link assembly for contact with the abutment face; characterised in that: a rearward end of each of the first and second flange in the widthwise direction terminates at a first region of the wall and a second region of the wall positioned at or towards the second side of the wall projects rearwardly beyond the rearward ends of the first and second flanges.

The present configuration of the flanges and force transmission wall provide the desired force transmission pathway thought the support frame (from the moveable jaw to the crusher main frame) to minimise stress concentrations at discrete regions and hence maximise the service lifetime of the support frame. Such a configuration also contributes to a weight reduction of the frame and hence the total weight of the crusher.

Preferably, the support frame further comprises a pair of end plates, the wall and the first and second flanges extending lengthwise between the end plates. The end plates may comprise a generally planar inward and outward facing surface and comprises a thickness being less than a respective thickness of the flanges and force transmission wall. The end plates provide a means of attaching the support frame to the main frame of the crusher as will be appreciated. Preferably, each of the end plates comprise an aperture aligned to interface with the cavity between the first and second flanges. Advantageously, each aperture comprises a length aligned with the longitudinal axis of the link assembly that extends approximately from the abutment face approximately to a forward end of the first and second flanges in the widthwise direction of the first and second flanges. Such a configuration is advantageous to provide means of accessing the cavity (defined between the flanges). Accordingly, wedge blocks, shim plates and toggle beams may be inserted and extracted at the support frame via the apertures. The apertures are dimensioned to be capable of operating in both shim and wedge setting. Additionally, the end plates are adapted to receive mounting brackets that may extend at least partially over regions of the apertures to mount additional components such as hydraulic rams or spacer blocks.

Preferably, each aperture comprises a width being substantially equal to a depth of the cavity between the first and second flanges.

Preferably, and to provide structural reinforcement of the support frame, regions of lengthwise ends of the first and second flanges (in particular each upper and lower corner of each flange) are enlarged to taper outwardly at the junction with the respective end plates. Additionally, the present support frame is further configured such that forwardmost lengthwise ends of the first and second flanges positioned closest to the movable jaw (each upper and lower corner of each flange closest to the movable jaw) are enlarged to taper in the forward direction towards the movable jaw. Preferably, the forwardmost ends (corners) of the first and second flanges taper outwardly in a plane transverse or perpendicular to the longitudinal axis of the link assembly. Such a configuration is advantageous to minimise stress concentrations at the lengthwise ends of the flanges that are positioned closest to the movable jaw.

Preferably, to maximise the reinforcement against loading forces, the second side of the wall is convex in the lengthwise direction such that a mid-length region extends rearwardly of respective lengthwise ends of the wall. To further reinforce the support frame against stress concentrations and loading forces it is preferred that the forward ends of the first and second flanges positioned to be facing the movable jaw are concave in the lengthwise direction such that a mid-length region is positioned rearward of respective forwardmost lengthwise ends of the first and second flanges (each upper and lower corner of each flange closest to the movable jaw).

Preferably, each flange comprises a lengthwise extending reinforcement rib positioned at or towards a forward end of the first and second flanges, each respective rib projecting outwardly from the first and second flanges in a direction away from the cavity. Preferably, the respective rib may comprise a squared C shape profile when the frame is viewed in plan. Preferably, parts of the reinforcement rib extend lengthwise at a forwardmost lengthwise edge of each flange. Additionally, it is preferred that the reinforcement rib also comprises respective components extending in the widthwise direction across each flange and positioned at each lengthwise end. Accordingly, the flanges are reinforced further at their respective lengthwise ends in addition to the lengthwise edge positioned closest to the movable jaw. Such a configuration is advantageous to minimise stress concentrations in use.

Optionally, a thickness of the wall extending in a plane perpendicular to the longitudinal axis of the link assembly is greater than a thickness of each of the first and second flanges.

Optionally, a thickness of the wall extending in a plane perpendicular to the longitudinal axis of the link assembly is in a range 60 to 180%, 60 to 160%, 80 to 120% or 80 to 100% of a corresponding depth of the cavity in the plane perpendicular to the longitudinal axis of the link assembly. In some aspects, a width of the wall in a direction of the longitudinal axis of the link assembly between the abutment face at the first side and a rear face at the second side of the wall is in the range 30 to 60% of a distance between a forwardmost lengthwise end (corner) of the first or second flange positioned closest to the movable jaw and the rear face at the second side of the wall.

According to a second aspect of the present invention there is provided a jaw crusher comprising: a movable jaw and a generally stationary jaw mounted in opposed relationship to define a crushing zone between the jaws; a drive mechanism coupled with the movable jaw and operative to oscillate the movable jaw relative to the stationary jaw in order to crush material in the crushing zone; a mechanically actuated link assembly connected to the movable jaw and configured to control movement of the movable jaw relative to the stationary jaw; and a support frame as claimed herein to support the movable jaw via the link assembly.

According to a third aspect of the present invention there is provided a jaw crusher support frame to support a movable jaw of a jaw crusher via a mechanically actuated link assembly connected to the movable jaw, at least a part of the link assembly configured to allow the movable jaw to oscillate relative to a substantially stationary jaw in order to crush material in a zone between the movable and stationary jaws, the support frame comprising: a force transmission wall having a first side to be forward facing towards the movable jaw and a second side to be rearward facing away from the movable jaw, the first side having an abutment face aligned to extend generally in a plane transverse or perpendicular to a longitudinal axis of the link assembly; a first and a second flange extending lengthwise along the wall and projecting widthwise forward from the first side of the wall to extend towards the movable jaw, a cavity defined between the first and second flanges to receive at least a part of the link assembly for contact with the abutment face; wherein each aperture is elongate to comprises a length aligned with the longitudinal axis of the link assembly that is greater than a width aligned transverse or perpendicular to a longitudinal axis.

Preferably, for each aperture a quotient of the aperture length/width is in the range 30 to 80%, 32 to 78%, 34 to 76%, 36 to 74%, 38 to 72%, or 40 to 60%.

Preferably, each end wall comprises a plurality of bore holes extending through the wall to receive mounting bolts. Preferably, the end walls comprise a cover plate or a wedge mount bracket attached to the end walls via attachment bolts received within the bore holes depending on whether the crusher is configured for operation in either a respective shim or wedge mode.

Optionally, the support frame comprises a ‘H’, ‘C’ or ‘Y’ shaped cross sectional profile in a central plane extending along the longitudinal axis.

### BRIEF DESCRIPTION OF DRAWINGS

A specific implementation of the present invention will now be described, by way of example only, and with reference to the accompanying drawings in which:

FIG. 1 is a cross sectional side view of a jaw crusher having a movable jaw support frame according to a specific implementation of the present invention with selected components removed for illustrative purposes;

FIG. 2 is a magnified view of the movable jaw support frame and a mechanical link assembly of FIG. 1 with selected components removed for illustrative purposes;

FIG. 3 is an external perspective view of the movable jaw support frame of FIG. 2 with selected components removed for illustrative purposes configured for operation in a wedge setting;

FIG. 4 is partial cross sectional perspective view of the movable jaw support frame of FIG. 2 adapted for operation in a shim setting according to a further specific implementation of the present invention with selected components removed for illustrative purposes;

FIG. 5 is an external perspective view of the support frame in the shim setting mode of FIG. 4;

FIG. 6 is a front perspective view of the movable jaw support frame of FIG. 2;

FIG. 7 is a rear perspective view of the movable jaw support frame of FIG. 6;

FIG. 8 is a plan view of the support frame of FIG. 7;

FIG. 9 is a lengthwise end view of the support frame of FIG. 8;

FIG. 10 is a cross sectional perspective view through K-K of the support frame of FIG. 8;

FIG. 11 is a further cross sectional perspective view through K-K of FIG. 8.

### DETAILED DESCRIPTION OF PREFERRED EMBODIMENT OF THE INVENTION

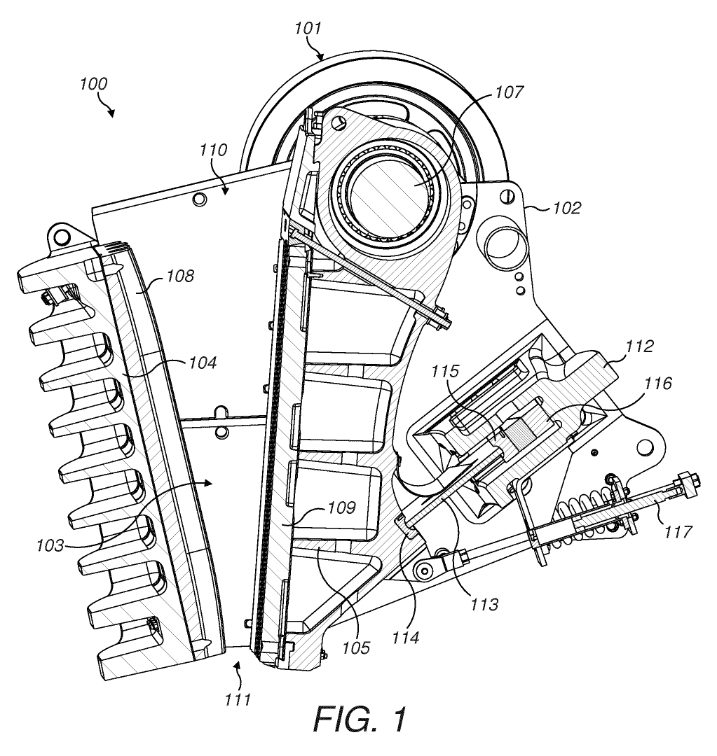

Referring to FIG. 1, a jaw crusher 100 comprises a main frame 102 mounting a movable jaw indicated generally by reference 105 and a fixed or stationary jaw indicated generally by reference 104. Movable jaw 105 is mounted eccentrically at a rotatable shaft 107 and is positioned separated and opposed to stationary jaw 104. A respective jaw plate 109 is mounted at movable jaw 105 and a corresponding jaw plate 108 is mounted at fixed jaw 104. A crushing zone indicated generally by reference 103 is defined between the opposed wear plates 109, 108 through which crushable material is allowed to fall. Jaws 104, 105 are arranged to be convergent towards their lower lengthwise ends such that an upper input end 110 of crushing zone 103 is enlarged relative to a lower discharge end 111. Material to be crushed is introduced into upper end 110, is crushed between jaw plates 108, 109 and is then discharge from lower end 111.

The gyratory oscillating movement of jaw 105 is controlled via a mechanically actuated link assembly. The link assembly comprises, according to the specific implementation, a toggle plate 113 having a first toggle beam 114 (mounted at a lower region of movable jaw 105) and a second toggle beam 115 (mounted and at least partially accommodated within a movable jaw support frame indicated generally by reference 112). The link assembly further comprises, according to the specific implementation, a pair of wedges 116 positioned in direct contact against support frame 112 at a rearwardmost end of the link assembly. Support frame 112 (commonly referred to as a back frame end) is mounted rigidly to crusher frame 102 and is configured to withstand impact loading forces resultant from the crushing action of jaw 105 as it oscillates by rotation of shaft 107 that is in turn actuated and controlled by a pair of pulley wheels 101 mounted each end of shaft 107. Conventional to jaw crushers, the present crusher 100 also comprises a retraction or tension assembly indicated generally by reference 117 mounted at a lower region of movable jaw 105 to apply a compressive force to or on the various components 113, 114, 115, 116 of the link assembly mounted between the jaw 105 and the support frame 112.

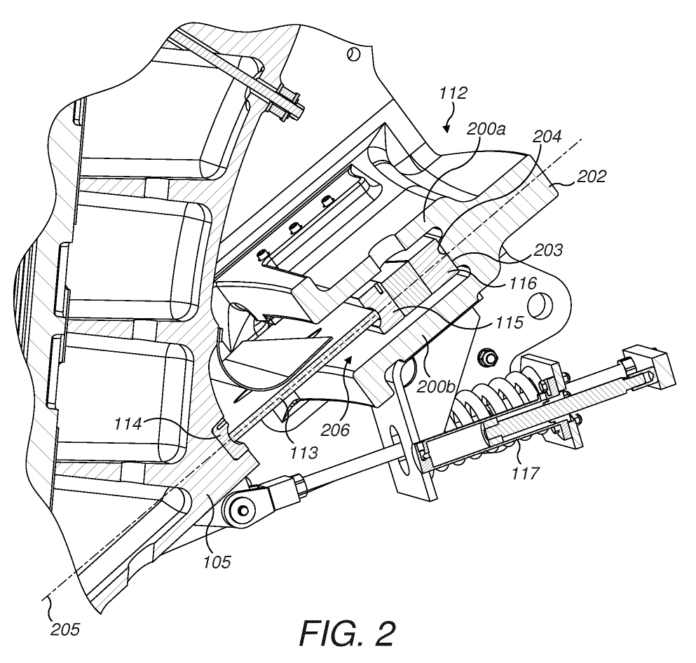

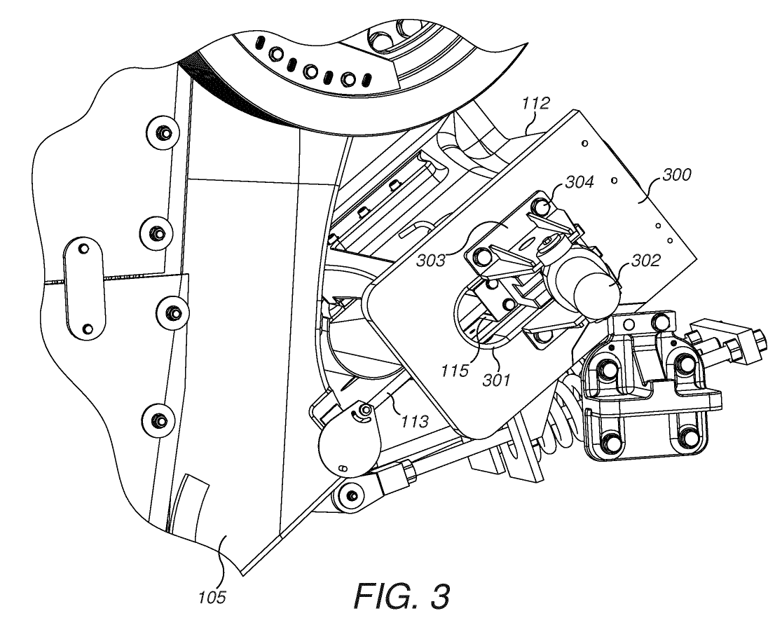

Referring to FIGS. 2 and 3, support frame 112 is formed as an integral rigid body comprising a pair of spaced apart and opposed first and second flanges 200a, 200b. Each flange 200a, 200b may be considered to be formed as a plate-like component having a respective length, width and thickness as will be described in further detail below. A cavity indicated generally by reference 206 is defined between the parallel opposed plate-like first and second flanges 200a, 200b, with cavity 206 dimensioned to receive and house wedges 116, second toggle beam 115 and a rearward end of toggle plate 113. Each of the first and second flanges 200a, 200b project forwardly towards movable jaw 105 from a force transmission wall indicated generally by reference 202. As with flanges 200a, 200b, wall 202 also comprises a length, width and thickness as will be described in detail below. The first and second flanges 200a, 200b project forward from a forward region of wall 202 such that when viewed in cross section, through a central region of support frame 112, the first and second flanges 200a, 200b and wall 202 collectively define a Y shape profile. As illustrated, the link assembly 113, 114, 115, 116 is aligned on a longitudinal axis 205 extending between movable jaw 105 and support frame 112. The plate-like first and second flanges 200a, 200b are aligned to comprise a width being parallel to axis 205 in a forward and rearward direction relative to movable jaw 105. Similarly, wall 202 comprises a corresponding width aligned with axis 205. Accordingly, the respective lengths of the first and second plate-like flanges 200a, 200b and wall 202 are aligned to extend substantially perpendicular to axis 205.

Wall 202 comprises a first side (positioned facing and towards movable jaw 105) that comprises a planar abutment face 204 aligned perpendicular to axis 205. The corresponding planar contact face 203 of the rearwardmost block of the wedge assembly 116 is positioned in contact with wall abutment face 204. Accordingly, the link assembly 113, 114, 115, 116 is maintained in fixed position under compression between support frame abutment face 204 and movable jaw 105.

Referring to FIGS. 2 and 3, frame 112 also comprises a pair of end plates 300 between which the first and second flanges 200a, 200b and wall 202 extend. Each end plate 300 comprises an elongate aperture 301. Each aperture 301 comprises a length aligned with axis 205 and a corresponding width that is approximately equal to a corresponding depth of cavity 206 between first and second flanges 200a, 200b. Accordingly, each aperture 301 provides a means to access cavity 206 from the lengthwise ends by support frame 112 that are positioned at the lateral sides of the crusher 100. When implemented in a wedge setting according to FIGS. 1 to 3, a set of wedge setting brackets 303 are rigidly secured to each end plate 300 to mount and support actuating rams 302 projecting from the lateral sides of crusher 100 that are configured to adjust the wedges 116 and in turn the positioning of the movable jaw 105 relative to the stationary jaw 104 as is customary to jaw crushers operating with wedge settings.

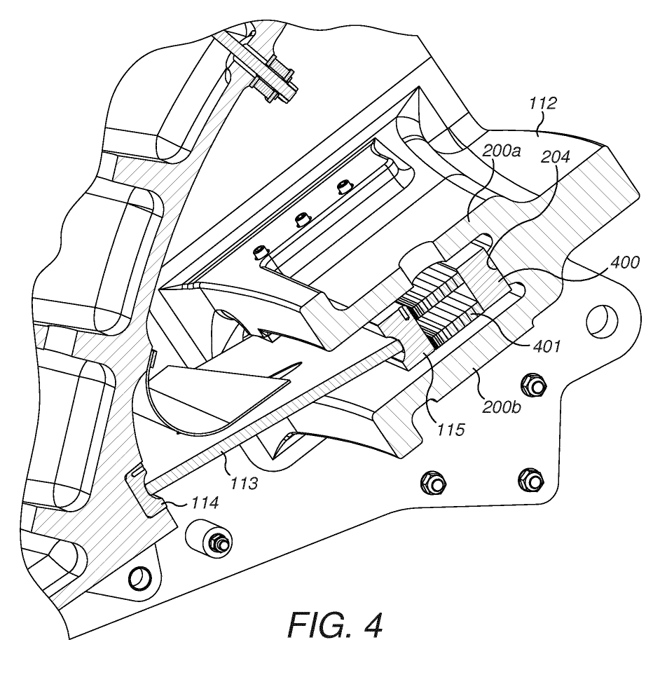

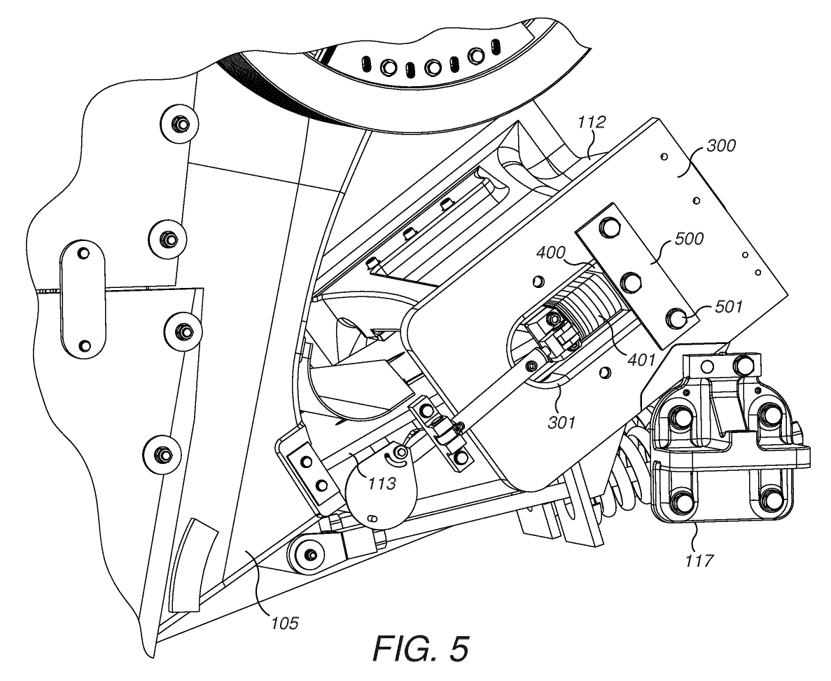

Advantageously, the present support frame 112 and crusher 100 is equally adapted for operation in a shim setting. In particular, support frame 112 is configured specifically to facilitate interchange between shim and wedge setting to avoid the need to structurally modify the support frame 112 which is otherwise required for conventional support frames (that typically involves welding, cutting and machining of the first and second flanges 200a, 200b, wall 202 and end plates 300). When implemented in shim setting according to the further embodiment of FIGS. 4 and 5, a set of shim plates 401 may be accommodated within cavity 206 between first and second flanges 200a, 200b. A spacer block 400 is positioned in direct contact against wall abutment face 204 and provides a rearwardmost end of the link assembly comprising toggle plate 113, first toggle beam 114 (mounted at jaw 105), second toggle beam 115, shim plates 401 and spacer block 400. As will be appreciated, the crusher 100 when operated in a shim setting configuration of FIGS. 4 and 5 also comprises the retraction or tension assembly 117 as described.

Referring specifically to FIG. 5, support frame 112 may be readily configured for use in the shim setting by the attachment of shim brackets 500 to end plates 300 that are secured over each rearward end of apertures 301 so as to reduce the length of each aperture 301 in the direction of axis 205. Shim bracket 500 comprises a generally plate-like body and is secured to a lateral side face of each end plate 300 via attachment bolts 501 secured through the same bores (not shown) extending through each end plate 300 that also mount the wedge brackets 303. Accordingly, with crusher 100 implemented in shim setting according to FIGS. 4 and 5, the crusher configuration may be changed to the wedge setting of FIGS. 1 to 3 by a user removing shim brackets 500 (via bolts 501) extracting shim plates 401 and spacer block 400 from cavity 206 via each respective aperture 301. The wedge blocks 116 may then be inserted into position between force transmission wall 202 and second toggle beam 115. The wedge blocks 116 are retained in position by mounting corresponding wedge brackets 303 at end plates 300 via attachment bolts 304. As is customary, hydraulic rams 302 are mounted at brackets 303 and extend laterally outward from the side walls of the crusher (not shown). Advantageously, no other structural modification is required to support frame 112, that is otherwise needed for conventional frames, so as to provide reinforcement against the larger magnitude forces transmitted to support frame 112 from jaw 105 when operating in wedge setting relative to shim setting. Accordingly, the present support frame 112 is advantageous to avoid a requirement to weld, cut and machine first and second flanges 200a, force transmission wall 202 and/or end plates 300.

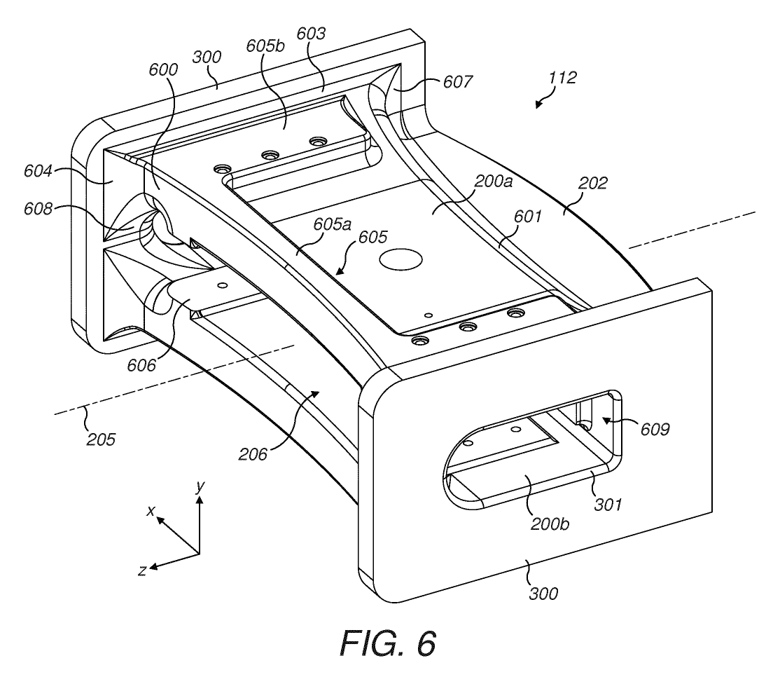

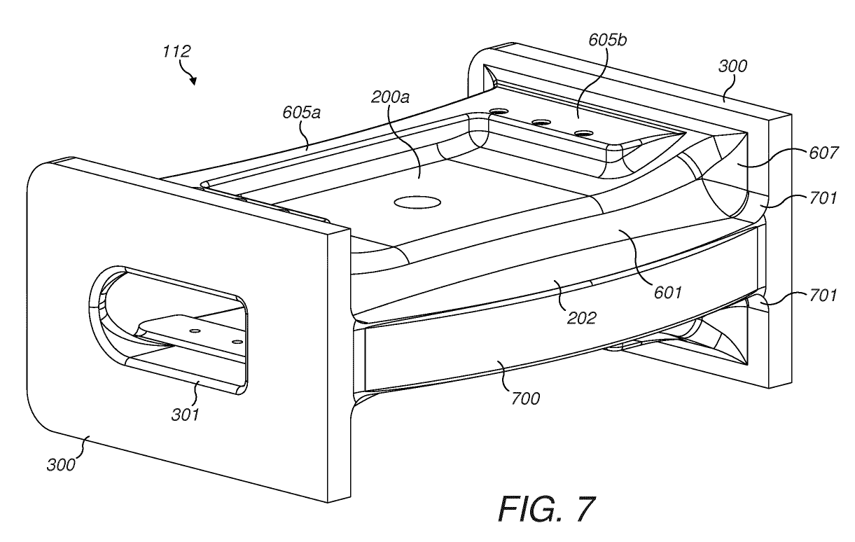

Referring to FIGS. 6 and 7, and as indicated each of the first and second flanges 200a, 200b comprise a length extending perpendicular to axis 205 in an X direction and a width being aligned with axis 205 extending in a Z direction. Each flange 200a, 200b comprises a corresponding thickness extending in a Y direction also perpendicular to axis 205. Accordingly, each of the first and second flanges 200a, 200b comprise respective lengthwise ends 603 that mate with respective inward facing sides of each end plate 300. The first and second flanges 200a, 200b also comprise a corresponding forward end 600 (positioned to be facing and closest to movable jaw 105) and a rearward end 601 with the width in the Z direction being defined between the ends 600, 601. Forward end 600 comprises a forward facing surface representing the lengthwise end of the plate-like first and second flanges 200a, 200b. Each of the forward ends 600 of each flange 200a, 200b is curved and in particular concave (relative to the main body of support frame 112) such that at mid-length region of each flange 200a, 200b is positioned rearward of respective flange forwardmost lengthwise ends 604 (each upper and lower corner of each flange 200a, 200b closest to the movable jaw that are provided at the junction with the end plates 300). Frame 112 is reinforced against stress concentrations and loading forces at lengthwise ends 603 as the thickness (in the Y direction) of each flange 200a, 200b is flared or tapered to increase at the junction with end plates 300. Additionally, the width of each flange 200a, 200b is increased (in the Z direction) at the junction with each plate 300 via flared or tapered lengthwise ends 604, 607 that project respectively forward and rearward (with respect to jaw 105) from the main body of each flange 200a, 200b at each end plate 300. Furthermore, the thickness (in the Y direction) of each flange 200a, 200b is further increased at the forwardmost end region (upper and lower corners closest to the jaw 105) of each lengthwise end 603 via a section 608 that is curved to taper downwardly into cavity 206 such that a corresponding depth of cavity 206 (between flanges 200a, 200b) at a position towards the flange lengthwise ends 603 decreases particularly at the forwardmost end regions positioned closest towards movable jaw 105.

Each flange 200a, 200b comprises a pair of saddle ribs 606 positioned towards each lengthwise end 603 that extend in the widthwise Z direction between forward and rearward ends 600, 601. Each rib 606 projects from each flange 200a, 200b into cavity 206 to appropriately seat wedges 116, toggle beam 115, shim plates 401 and/or spacer block 400. Each flange 200a, 200b also comprises a respective reinforcement rib 605 that projects outwardly at support frame 112 in the Y direction away from cavity 206. Each reinforcement rib 605 comprises an elongate component 605a extending lengthwise (in the X direction) along each flange 200a, 200b and positioned at each flange forward end 600. Each reinforcement rib 605 further comprises a component 605b extending widthwise (in the Z direction) of each flange 200a, 200b between forward and rearward ends 600, 601 and positioned towards flange lengthwise ends 603. The reinforcement rib 605 is formed as a raised projection extending from each respective flange 200a, 200b so as to increase the thickness of each flange 200a, 200b in the Y direction at the forward ends 600 and the lengthwise ends 603. According to the specific embodiment, each reinforcement rib 605 comprises a ‘C’ shape configuration and extends along the full length and 80 to 90% of the width of each flange 200a, 200b in the respective X and Z directions. Additionally, each rib 605 comprises a thickness (in the Y direction) that is approximately equal to a thickness of the remainder (or the majority) of each flange 200a, 200b.

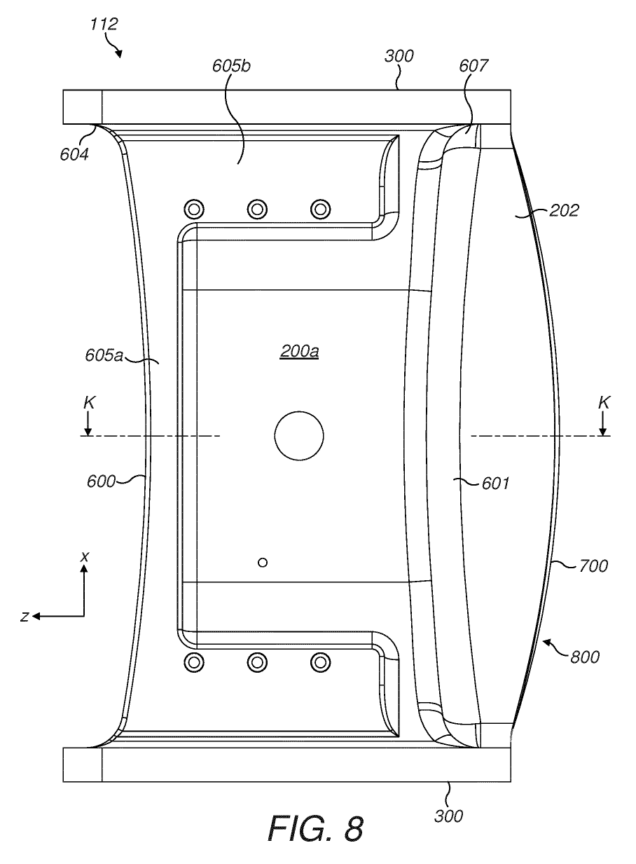

Referring to FIG. 7, the rearward ends 601 of each flange 200a, 200b are curved to transition smoothly into reinforcement wall 202. Referring to FIGS. 7 and 8, reinforcement wall 202 may be considered to be formed as a generally rectangular block in which a forward end region (closest to movable jaw 105) is positioned intermediate the rearward ends 601 of each flange 200a, 200b. Accordingly, force transmission wall 202 comprises a length also extending in the X direction, a width extending in the Z direction and a thickness extending in the Y direction. As illustrated, the flanges 200a, 200b, the force transmission wall 202 and the end plates 300 are formed integrally via a cast moulding process. Wall 202 comprises a forward end indicated generally by reference 609 (referring to FIG. 6) and a rearward end 800 (referring to FIG. 8) with the width of wall 202 defined between the forward and rearward ends 609, 800 in the Z direction.

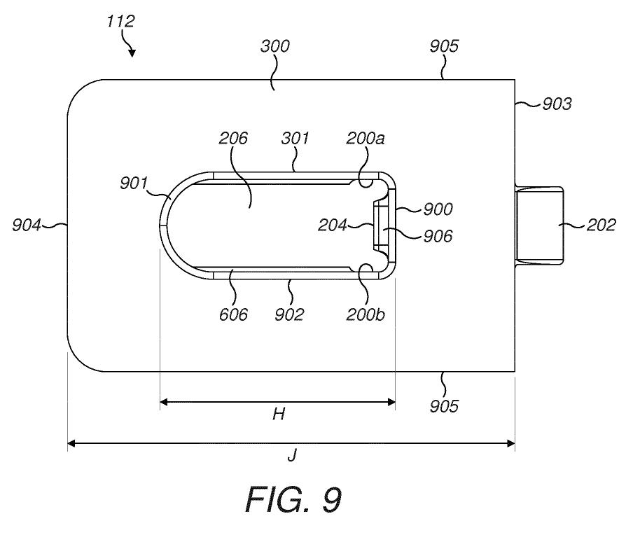

Referring to FIGS. 9 to 11, a reinforcement shoulder 906 projects from forward end 609 into a rearward end region of cavity 206. Shoulder 906 defines the planar abutment face 204 for contact with the wedges 116 (or shim spacer block 400). Wall rearward end 800 is curved in a lengthwise direction between respective lengthwise ends 701 and is in particular convex with regard to the main body of wall 202. According to the specific implementation, a curvature of the rearward end 800 of wall 202 is greater than the curvature of concave forward end 600 of each flange 200a, 200a. Wall 202 is reinforced against stress concentrations and loading forces by comprising a thickness in the Y direction that increases at the lengthwise ends 701. In particular, the thickness of wall 202 at the lengthwise end 701 is flared (and in particular is curved) to taper outwardly at the junction with each end plate 300.

Referring to FIG. 9, each end plate comprises a forward edge 904, a rearward edge 903 and a pair of side edges 905. Edges 905 extend in the Z direction whilst the forward and rearward edges 904, 903 extend in the Y direction. Each aperture 301 comprises a corresponding pair of lengthwise edges 902, a rearward end edge 900 and a forward end edge 901. Forward end edge 901 is curved to comprise a semi-circular shape profile. Accordingly, each aperture 301 is elongate in the lengthwise direction of each end plate 300 in the Z direction corresponding to the direction of axis 205. According to the specific implementation a length H of each aperture 301 (between forward and rearwardmost end edges 901, 900) is 40 to 60% and preferably 45 to 55% of a length J of plate 300 (between forward and rearward end edges 904, 903).

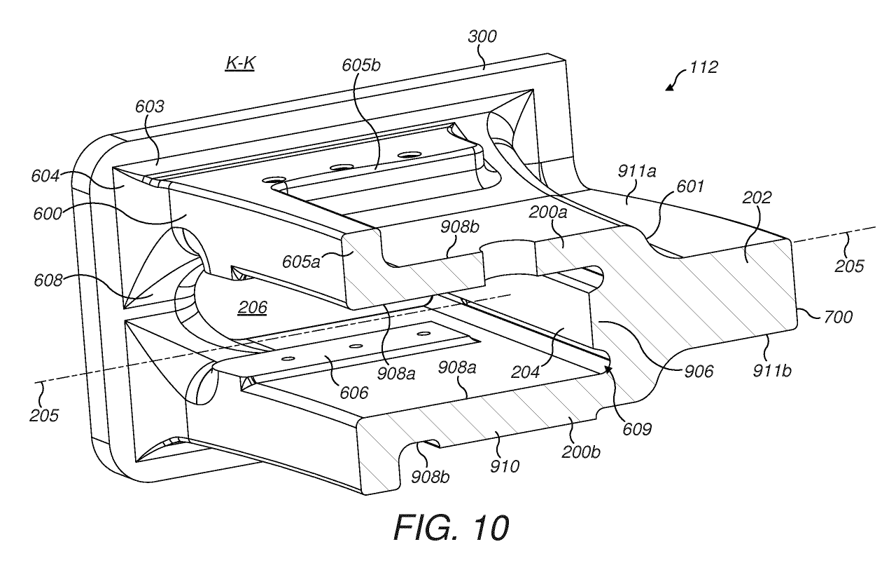

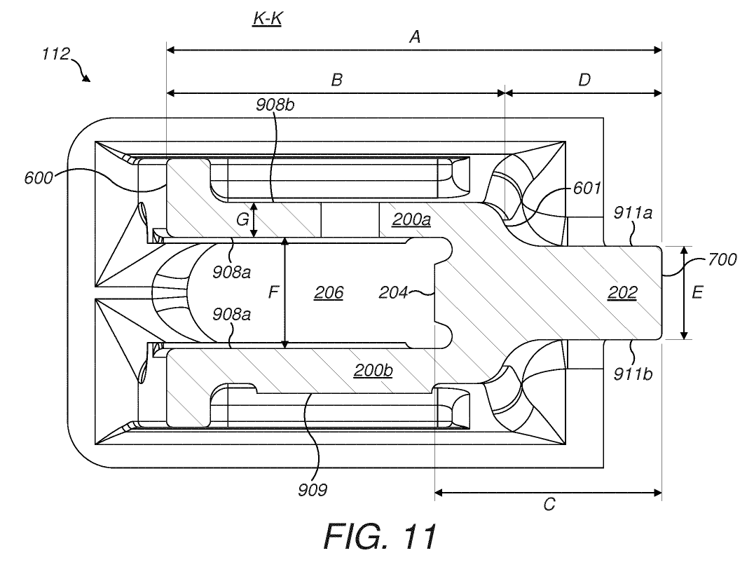

Referring to FIGS. 10 and 11, the first and second flanges 200a, 200b each comprise an inward facing surface 908a that in part defines cavity 206 (in combination with abutment face 204) with saddle ribs 606 projecting from each surface 908a. Each flanges 200a, 200b also comprises an outward facing surface 908b from which each respective reinforcement rib 605 extends. Accordingly, a thickness of the flanges 200a, 200b is defined between surfaces 908a, 908b. A further reinforcement rib 910 also projects from outward facing surface 908b at the second flange 200b. Rib 910 is positioned generally centrally at flange 200b (which is the lower of the two flanges 200a, 200b when the frame 100 is mounted at the crusher 100) within the perimeter of surface 908b as defined by the forward and rearward ends 600, 601 and lengthwise ends 603.

Referring to FIG. 11, the majority of each flange 200a, 200b projects forward from reinforcement wall 202 in the Z direction such that cavity 206 is defined substantially by the complete width and length of each flange 200a, 200b in the Z-X plane. That is, according to the specific implementation, less than 20% in the widthwise Z direction of each flange 200a, 200b is mated with the force transmission wall 202. Additionally, the majority of the force transmission wall 202 projects rearwardly from each flange 200a, 200b and in particular the rearward end 601 of each flange 200a, 200b. In particular, a rearward region (in the Z direction) of wall 202 represents a rearwardmost part of the support frame 112. The flanges 200a, 200b extend from the forward region of wall 202 such that the majority of wall 202 extends rearwardly beyond flanges 200a, 200b.

To minimise stress concentrations and provide a reversible, convenient and efficient interchangeable configuration between shim and wedge setting, the flanges 200a, 200b and the force transmission wall 202 are specifically configured with regard to shape, relative dimensions and configuration. This is in addition to the reinforcement provided by the ribs 605, 910 and 606. As indicated, a contribution to the reinforcement against stress concentrations and resistance to loading forces is provided by the enhanced thickness in the Y direction at lengthwise ends 603, 604, 607, 608 and 701 with regard to the flanges 200a, 200b and the force transmission wall 202. Referring to FIG. 11, reference A corresponds to the distance between an end face of each flange 200a, 200b at forward end 600 and face 700 in the Z direction; reference B corresponds to the distance between face 600 and a mid-point of the rearward end 601 in the Z direction; reference C corresponds to the distance between abutment face 204 and wall face 700 in the Z direction; reference D corresponds to the distance between the mid-point of rearward end 601 and wall face 700. Additionally, reference E corresponds to a thickness of wall 202 in the Y direction between a planar upward facing surface 911a and a parallel and planar downward facing surface 911b; reference F corresponds to the depth of the cavity 206 between the opposed surfaces 908a of the flanges 200a, 200b and reference G corresponds to the thickness in the Y direction of each flange 200a, 200b between the opposite inward and outward facing surfaces 908a, 908b respectively.

According to the specific implementation, the quotient D/A is 20 to 40% and preferably 29 to 33%; the quotient B/A is 60 to 80% and preferably 66 to 70%; the quotient C/A is 35 to 55% and preferably 44 to 48%; the quotient D/C is 60 to 80% and preferably 67 to 71% and the quotient C/B is 60 to 80% and preferably 65 to 69%. Additionally, the quotient G/E is 30 to 50% and preferably 36 to 40%; the quotient E/F is 70 to 90% and preferably 81 to 85%; and the quotient G/F is 20 to 40% and preferably 30 to 34%.

1. A jaw crusher support frame arranged to support a movable jaw of a jaw crusher via a mechanically actuated link assembly connected to the movable jaw, at least a part of the link assembly being configured to allow the movable jaw to oscillate relative to a substantially stationary jaw in order to crush material in a zone between the movable and stationary jaws, the support frame comprising:
a force transmission wall having a first side arranged to be forward facing towards the movable jaw and a second side arranged to be rearward facing away from the movable jaw, the first side having an abutment face aligned to extend generally in a plane transverse or perpendicular to a longitudinal axis of the link assembly; and
a first and a second flange extending lengthwise along the wall and projecting widthwise forward from the first side of the wall to extend towards the movable jaw, a cavity defined between the first and second flanges being arranged to receive at least a part of the link assembly for contact with the abutment face, wherein a rearward end of each of the first and second flanges in the widthwise direction terminates at a first region of the wall and a second region of the wall positioned at or towards the second side of the wall projects rearwardly beyond the rearward ends of the first and second flanges.

2. The support frame as claimed in claim 1, wherein the frame includes a pair of end plates, the wall and the first and second flanges extending lengthwise between the end plates.

3. The support frame as claimed in claim 2, wherein each of the end plates have an aperture aligned to interface with the cavity between the first and second flanges.

4. The support frame as claimed in claim 2, wherein each aperture has a length aligned with the longitudinal axis of the link assembly that extends approximately from the abutment face approximately to a forward end of the first and second flanges in the widthwise direction of the first and second flanges.

5. The support frame as claimed in claim 4, wherein each aperture has a width being substantially equal to a depth of the cavity between the first and second flanges.

6. The support frame as claimed in claim 4, wherein regions of lengthwise ends of the first and second flanges are enlarged to taper outwardly at the junction with the respective end plates.

7. The support frame as claimed in claim 6, wherein forwardmost lengthwise ends of the first and second flanges positioned closest to the movable jaw are enlarged to taper in the forward direction towards the movable jaw.

8. The support frame as claimed in claim 7, wherein the forwardmost ends of the first and second flanges taper outwardly in a plane transverse or perpendicular to the longitudinal axis of the link assembly.

9. The support frame as claimed in claim 1, wherein the second side of the wall is convex in the lengthwise direction such that a mid-length region extends rearwardly of respective lengthwise ends of the wall.

10. The support frame as claimed in any claim 1, wherein a forward end of the first and second flanges positioned to be facing the movable jaw are concave in the lengthwise direction such that a mid-length region is positioned rearward of respective forwardmost lengthwise ends of the first and second flanges.

11. The support frame as claimed in claim 1, wherein each flange has a lengthwise extending reinforcement rib positioned at or towards a forward end of the first and second flanges, each respective reinforcement rib projecting outwardly from the first and second flanges in a direction away from the cavity.

12. The support frame as claimed in claim 1, wherein a thickness of the wall extending in a plane perpendicular to the longitudinal axis of the link assembly is greater than a thickness of each of the first and second flanges.

13. The support frame as claimed in claim 1, wherein a thickness of the wall extending in a plane perpendicular to the longitudinal axis of the link assembly is in a range 80 to 100% of a corresponding depth of the cavity in the plane perpendicular to the longitudinal axis of the link assembly.

14. The support frame as claimed in claim 1, wherein a width of the wall in a direction of the longitudinal axis of the link assembly between the abutment face at the first side and a rear face at the second side of the wall is in the range 30 to 60% of a distance between a forwardmost lengthwise end of the first or second flange positioned closest to the movable jaw and the rear face at the second side of the wall.

15. A jaw crusher comprising:
a movable jaw and a generally stationary jaw mounted in an opposed relationship to define a crushing zone therebetween;
a drive mechanism coupled with the movable jaw and operative to oscillate the movable jaw relative to the stationary jaw in order to crush material in the crushing zone;
a mechanically actuated link assembly connected to the movable jaw and configured to control movement of the movable jaw relative to the stationary jaw; and
a support frame as claimed in claim 1, to support the movable jaw via the link assembly.
